(19) United States
(12) Patent Application Publication
(10) Pub. No.: US 2006/0225577 A1
(43) Pub. Date: Oct. 12, 2006

(54) Beverage making device comprising a brewing chamber and a water outlet

(76) Inventors: Roelf Mulder, Drachten (NL); Hans Kodden, Hoogeveen (NL); Josephus Wilhelmus Maria Ter Burg, Drachten (NL)

Correspondence Address: PHILIPS INTELLECTUAL PROPERTY & STANDARDS, P.O. BOX 3001, BRIARCLIFF MANOR, NY, 10510, US

(21) Appl. No.: 10/568,475

(22) PCT Filed: Aug. 4, 2004
(86) PCT No.: PCT/IB04/51386

§ 371 Date: Feb. 15, 2006

(30) Foreign Application Priority Data
Aug. 18, 2003 (EP) 03102584.4

(51) Int. Cl. A47J 31/00; A47J 31/44

(52) U.S. Cl. 99/279

(57) ABSTRACT

A beverage making device comprising a brewing chamber (5). The brewing chamber (5) is defined by an upper wall (4) with one or more holes (3) through which heated water can enter the brewing chamber (5), and by the wall of a first removable part having an edge that can abut against said upper wall (4) via first sealing means (19) in order to form the brewing chamber (5). The first removable part is provided with outlet means (8) for guiding brewed liquid out of the brewing chamber (5). There is a second removable part comprising means for guiding the heated water from said one or more holes (3) to outside the device, where the heated water can be caught in one or more cups. The second removable part is interchangeable with said first removable part.

The invention relates to a beverage making device comprising a brewing chamber, the brewing chamber being defined by an upper wall with one or more holes through which heated water can enter the brewing chamber, and by the wall of a first removable part having an edge that can abut against said upper wall via first sealing means in order to form the brewing chamber, said first removable part being provided with outlet means for guiding brewed liquid out of the brewing chamber.

Such a device—for preparing coffee—is described in WO-A-01/15582. The described device comprises a water reservoir and means for heating the water and pumping it to the holes in the upper wall of the brewing chamber, so that the heated water can enter the brewing chamber under pressure. The brewing chamber is filled with a pad containing ground coffee, and the heated water will pass through the pad, so that the coffee is extracted. After the extraction process, the liquid (coffee) leaves the brewing chamber through outlet means, i.e. an opening in the bottom of the brewing chamber, and enters a liquid receiving chamber. The liquid receiving chamber comprises two parallel outflow pipes extending outside the device, so that the brewed coffee can be caught by one or by two cups. The portion of the device comprising the upper wall of the brewing chamber can hinge upward to give access to the brewing chamber, so that the pad can be renewed for a next extraction process. In the upward position of said portion, the part of the device comprising the side wall and the lower wall of the brewing chamber as well as the liquid receiving chamber and the outflow pipes can be removed from the device, for example for cleaning said part or for replacing the part with another, similar part in which the brewing chamber is larger, so that two pads can be placed in it in order to brew enough beverage for two cups instead of one cup.

The device can produce a beverage by an extraction process, for example when producing coffee, or by a dissolving process, for example when producing a chocolate drink. In the case of an extraction process, the extracted substance will remain in the brewing chamber and must be removed from that chamber afterwards. In the case of a dissolving process, the substance in the brewing chamber will disappear during the brewing process.

The said removable part of the beverage making device may comprise a further chamber, for example a frothing chamber, where the brewed beverage is brought into turbulence, so that foam is created.

Although the described device is intended for making coffee, it is also possible to produce hot water, for example for making tea. In that case there is no pad in the brewing chamber, so that the heated water leaves the brewing chamber without extracting coffee. The heated water will subsequently flow though the outflow pipes and can be caught by one or two cups. However, after the beverage making device has been used for preparing coffee, there will always be a taste of coffee in the water that is heated afterwards in the device. Especially when making tea, even a slight hint of coffee will affect the flavor of the beverage.

The object of the invention is to provide a beverage making device that can be used for making coffee and also for making hot water without any tang, for example to make tea.

In order to accomplish that objective, a second removable part is present, which part comprise means for guiding the heated water from said one or more holes to outside the device, where the heated water can be caught in one or more cups, which second removable part is interchangeable with said first removable part. Said first removable part comprises practically all portions that have been in contact with the brewed beverage and that may cause a tang. After the first removable part has been replaced with the second removable part, the heated water flowing through the holes in the upper wall of the brewing chamber is guided to outside the device without coming into contact with portions of the device that have contacted the previously brewed liquid.

Depending on the design of the device, the heated water may contact the upper wall of the brewing chamber, and it may be necessary to avoid such a contact in order to keep the water without any tang. Therefore, in a preferred embodiment, said second removable part comprises second sealing means for abutting against said upper wall around one or more of said holes, so that the water cannot contact the upper wall of the brewing chamber.

In one preferred embodiment, said second sealing means are tubular members made from a flexible material, the inner diameter of said members corresponding to the inner diameter of said holes. This creates a watertight connection between the relevant hole and second removable part, so that the water cannot contact portions of the upper wall of the brewing chamber.

In one preferred embodiment, said second removable part comprises restriction means in order to limit the amount of heated water passing through said holes, which restriction means are preferably located near said one or more holes. Such restriction means may limit the amount of water pumped through the holes, similar to the resistance of a pad containing ground coffee.

The upper wall of the brewing chamber may be provided with a number of holes in order to distribute the water over the entire pad during the brewing process. Such a distribution of water is not required if the heated water is guided to outside the device. Therefore, in a preferred embodiment, said second removable part comprises means for closing one or more of said holes.

Preferably, said means for guiding the heated water to outside the device comprise two outlets for the water, so that two cups can be simultaneously filled with heated water.

The invention also relates to a water outlet module in the form of a second removable part for a beverage making device comprising a brewing chamber, the brewing chamber being defined by an upper wall with one or more holes through which heated water can enter the brewing chamber, and by the wall of a first removable part having an edge that can abut against said upper wall via first sealing means in order to form the brewing chamber, said first removable part being provided with outlet means for guiding brewed liquid out of the brewing chamber, wherein the water outlet module is a second removable part comprising means for guiding the heated water from said one or more holes to outside the device, where the heated water can be caught in one or more cups, which second removable part is interchangeable with said first removable part.

The invention furthermore relates to a method of making a beverage by means of a beverage making device comprising a brewing chamber, the brewing chamber being defined by an upper wall with one or more holes through which heated water can enter the brewing chamber, and by the wall of a first removable part having an edge that can abut against said upper wall via first sealing means in order to form the brewing chamber, said first removable part being provided with outlet means for guiding brewed liquid out of the brewing chamber, wherein said first removable part is replaced with a second removable part comprising means for guiding the heated water from said one or more holes to outside the device, where the heated water is caught in one or more cups.

The invention will now be explained by means of a description of an embodiment of a device for making coffee, in which reference is made to the drawing, in which:

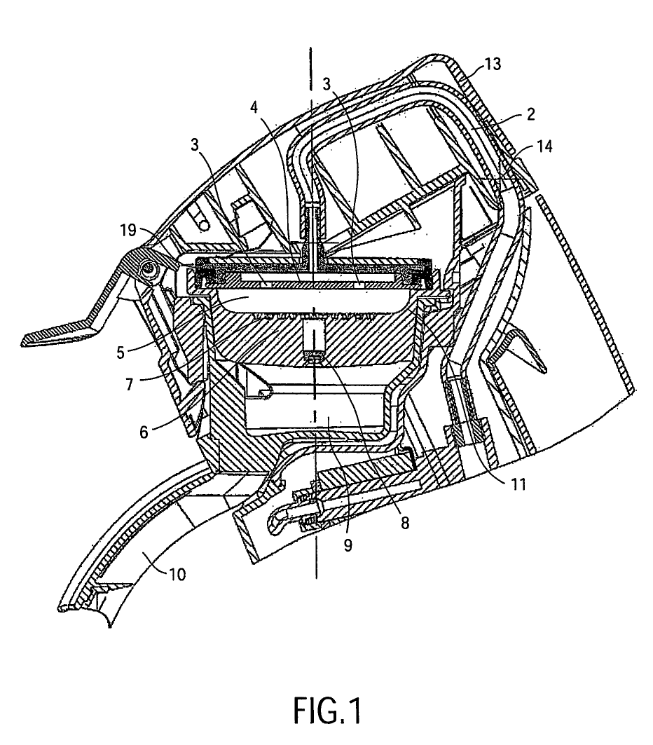

FIG. 1 is a sectional view of a portion of the device,

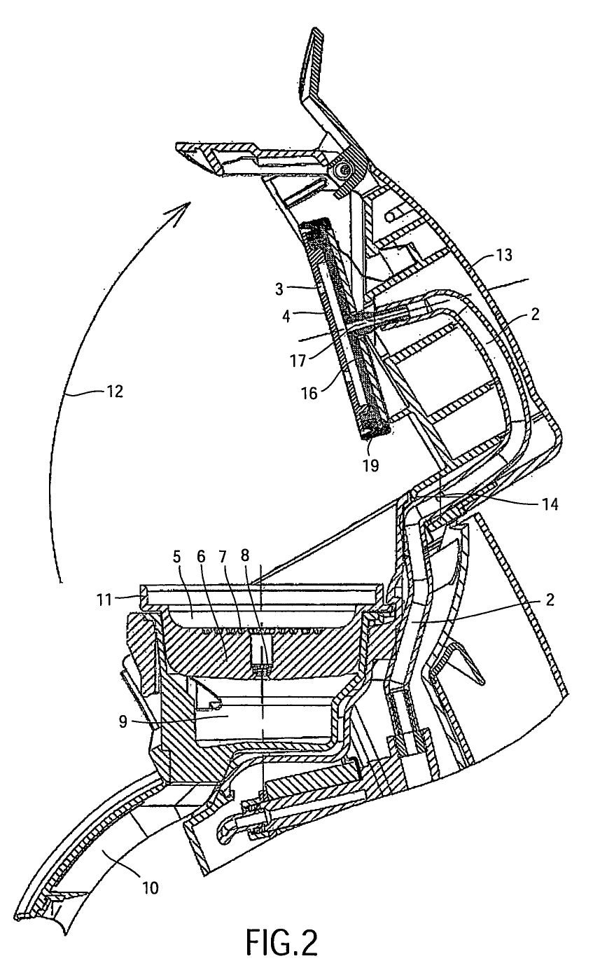

FIG. 2 show the device with the brewing chamber in open position,

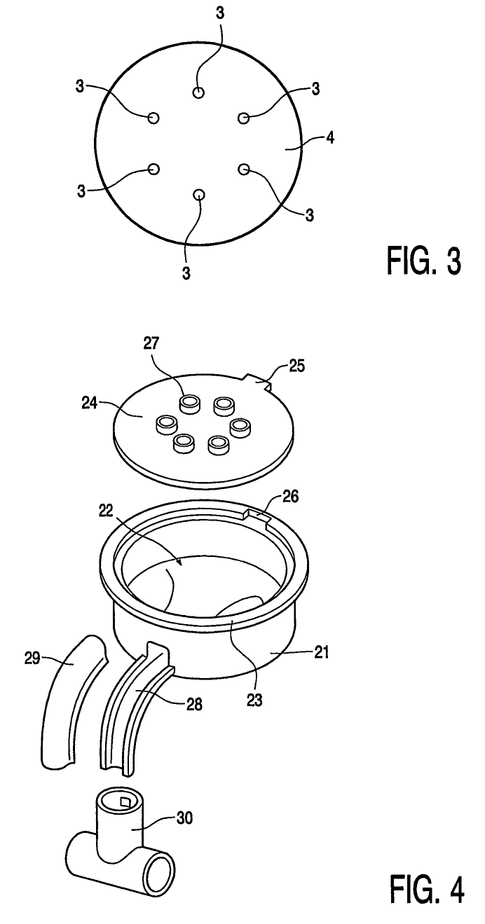

FIG. 3 is a view of the lower side of the upper wall of the brewing chamber, and

FIG. 4 is an exploded view of a second removable part.

FIG. 1 shows the relevant part (i.e. the uppermost portion) of a device for making coffee. The other part of the device, which is not shown, comprises a water container and means for heating the water and pumping a predetermined quantity of the heated water through tube 2 to six holes 3 in the upper wall 4 of the brewing chamber 5. In the sectional view of FIG. 1, only two holes 3 in the upper wall 4 are shown. Brewing chamber 5 has a substantially cylindrical shape so as to fit a disc-like pad (not shown) containing, for example, ground coffee.

The lower wall 6 of the brewing chamber 5 is provided with a profile 7 that forms channels for allowing the brewed coffee to arrive at the central part of the bottom of the brewing chamber 5, so that the liquid can flow to the outflow opening 8 in the lower wall 6. The brewed coffee is collected in a liquid receiving chamber 9 and subsequently guided through two outflow tubes 10 extending outside the device to a location where the brewed coffee can be caught by one or by two cups (not shown). There are two outflow tubes 10 parallel to each other, so that each outflow tube 10 can guide brewed coffee to one of two cups, which cups are standing near each other. If only one cup is to be filled, both outflow tubes 10 guide the brewed coffee to the same cup. Since the two outflow tubes 10 are located on either side of the plane of drawing, they are not visible in the sectional views of FIG. 1 and FIG. 2.

The brewing chamber 5 as shown in FIG. 1 has a dimension to accommodate a pad containing ground coffee for brewing coffee for one cup. If two cups of coffee are to be brewed, the part 11 of the device can be replaced by another part 11, which other part (not shown) comprises a thinner lower wall 6, so that the height of the brewing chamber 5 is increased such that the brewing chamber 5 can accommodate two pads containing ground coffee, or a bigger pad, to brew enough coffee for two cups.

The upper wall 4 of the brewing chamber 5 has a disc-like shape and is clamped in a connecting piece 16 comprising a central water duct 17 which is connected to tube 2, as is shown in FIGS. 1 and 2. The water can flow from the duct 17 through the space between the upper wall 4 and the connecting piece 16 to the six holes 3 in the upper wall 4. Around the connecting piece 16 there is a sealing ring 19 (first sealing means) to provide a watertight sealing between the removable part 11 and the upper wall 4 when the brewing chamber 5 is closed (FIG. 1).

As is shown in FIG. 2 by arrow 12, the device can be opened by hinging the upper part 13 of the device about axis 14. The upper wall 4 of the brewing chamber 5 is connected to said upper part 13, so that the brewing chamber 5 becomes accessible after opening. A used pad may then be removed and/or a new pad may be placed in the brewing chamber 5. If the next brewing process is to be performed with two pads, the open position of the brewing chamber allows the replacement of part 11 of the device with another one having a larger brewing chamber 5. To enable the hinging movement of the upper part 13, the tube 2 is made of a flexible material.

FIG. 3 is a view of the lower side of the upper wall 4 of the brewing chamber 5, showing the locations of the six holes 3. The six holes 3 distribute the heated water over the pad in the brewing chamber 5, so that the extraction process takes place in the entire pad in an effective way.

In the opened position of the device as shown in FIG. 2, the part of the device comprising the brewing chamber 5 (except for its upper wall 4), the liquid receiving chamber 9, and the outflow tubes 10 (together called the first removable part) can be removed from the device, so that the part can be cleaned and then put back in the device. However, if the device is used for producing hot water, for example for making tea, said part can be interchanged with a second removable part, which part is shown in FIG. 4.

FIG. 4 is an exploded view showing the second removable part. The second removable part comprises a main body 21 comprising a water collection chamber 22. In order to be supported in the device, the main body 21 is provided with a flange 23 at its upper edge. The shape of flange 23 corresponds to the shape of the upper portion of the first removable part, so that the second removable part is supported in the device in the same way as the first removable part.

At its top side, the water collection chamber 22 is covered by a cover plate 24. Cover plate 24 has a protrusion 25 corresponding to a notch 26 in the flange 23, so that cover plate 24 fits in the main body in only one predetermined position. Cover plate 24 is provided with six short tubes 27 made of flexible material. When the second removable part is present in the closed device, the six tubes 27 correspond to the six holes 3 in the upper wall 4. Each of the tubes 27 abuts the upper wall 4 around a hole 3 and forms a second sealing, so that the water leaving the holes 3 arrives in the water collection chamber 22 without contacting the lower side of the upper wall 4.

The cover plate 24 may be provided with six bores (not shown) corresponding to the six tubes 27, so that the heated water from all six holes 3 can flow into the water collection chamber 22. However, it may be advantageous to make use of only one or two tubes 27 to guide the water to the water collection chamber 22, in which case only these tubes 27 will correspond to a bore in the cover plate 24. The other flexible tubes 27 close the corresponding holes 3, so that no water flows through these holes 3. The bores in the cover plate 24 can thus form a restriction to limit the water flow to the collection chamber 22.

A water outflow member 28 is provided at the lower side of the main body 21 for guiding the heated water to outside the device, similar to the outflow pipes 10 of the first removable part. Water outflow member 28 may be provided with a cover 29 and may carry a water distributor 30 at its end. The use of the water distributor 30 enables two cups to be filled simultaneously with hot water. Of course, it is also possible to provide the second removable part with two outflow pipes like the outflow pipes 10 of the first removable part.

The embodiment of FIG. 4 comprises a rather large water collection chamber 22, which may cause an undesired drop in temperature of the water while it is being guided from the holes 3 to the outflow member 28. To limit this temperature drops, there may be a direct connection between the holes 3 and the water outflow member 28 in the form of one or more tubes or the like.

The embodiment as described above is merely an example of the device; a great many other embodiments are possible.

1. A beverage making device comprising a brewing chamber (5), the brewing chamber (5) being defined by an upper wall (4) with one or more holes (3) through which heated water can enter the brewing chamber (5), and by the wall of a first removable part having an edge that can abut against said upper wall (4) via first sealing means (19) in order to form the brewing chamber (5), said first removable part being provided with outlet means (8) for guiding brewed liquid out of the brewing chamber (5), characterized by a second removable part comprising means for guiding the heated water from said one or more holes (3) to outside the device, where the heated water can be caught in one or more cups, which second removable part is interchangeable with said first removable part.

2. A beverage making device as claimed in claim 1, characterized in that said outlet means (8) of said first removable part guide the liquid into another chamber (9).

3. A beverage making device as claimed in claim 1, characterized in that said second removable part comprises second sealing means (27) for abutting against said upper wall (4) around one or more of said holes (3).

4. A beverage making device as claimed in claim 3, characterized in that said second sealing means (27) are tube-like members made from a flexible material.

5. A beverage making device as claimed in claim 1, characterized in that said second removable part comprises restriction means in order to limit the amount of heated water passing through said one or more holes (3).

6. A beverage making device as claimed in claim 5, characterized in that the restriction means are located near said one or more holes (3).

7. A beverage making device as claimed in claim 1, characterized in that said second removable part comprises means for closing one or more of said holes (3).

8. A beverage making device as claimed in claim 1, characterized in that said means for guiding the heated water to outside the device comprise two outlets for the water, so that two cups can be simultaneously filled with heated water.

9. A water outlet module in the form of a second removable part for a beverage making device comprising a brewing chamber (5), the brewing chamber (5) being defined by an upper wall (4) with one or more holes (3) through which heated water can enter the brewing chamber (5), and by the wall of a first removable part having an edge that can abut against said upper wall (4) via first sealing means (19) in order to form the brewing chamber (5), said first removable part being provided with outlet means (8) for guiding brewed liquid out of the brewing chamber (5), characterized in that the water outlet module is a second removable part comprising means for guiding the heated water from said one or more holes (3) to outside the device, where the heated water can be caught in one or more cups, which second removable part is interchangeable with said first removable part.

10. A method of making a beverage by means of a beverage making device comprising a brewing chamber (5), the brewing chamber (5) being defined by an upper wall (4) with one or more holes (3) through which heated water can enter into brewing chamber (5), and by the wall of a first removable part having an edge that can abut against said upper wall (4) via first sealing means (19) in order to form the brewing chamber (5), said first removable part being provided with outlet means (8) for guiding brewed liquid out of the brewing chamber (5), characterized in that said first removable part is replaced with a second removable part comprising means for guiding the heated water from said one or more holes (3) to outside the device, where the heated water is caught in one or more cups.
